(19) United States
(12) Patent Application Publication
(10) Pub. No.: US 2015/0120411 A1
(43) Pub. Date: Apr. 30, 2015

(54) MERCHANT OFFER RECOMMENDATION SYSTEM

(71) Applicant: Ben Kneen, Boston, MA (US)

(72) Inventor: Ben Kneen, Boston, MA (US)

(21) Appl. No.: 14/063,880

(22) Filed: Oct. 25, 2013

(51) Int. Cl. G06Q 30/02

(52) U.S. Cl. CPC G06Q 30/0211
USPC 705/14.13

(57) ABSTRACT

Systems and methods for recommending offers to merchants for provision to their customers include a database storing customer offer data for a plurality of customers and a plurality of offers and that details the results of providing one or more of the plurality of offers to each of the plurality of customers. Identifying information about a first merchant is received and used to retrieve a first subset of the plurality of customers that are associated with the first merchant. The first subset of the plurality of customers is used to review the customer offer data to determine the results of providing the one or more of the plurality of offers to each of the first subset of customers. A first offer that is associated with a higher amount of participation results by the first subset of the plurality of customers relative to the others of the plurality of offers is then determined and provided for display to the first merchant.

### BACKGROUND

1. Field of the Invention

The present disclosure generally relates to online and/or mobile payments and more particularly to merchant offer recommendation system for recommending offers for merchants to provide to customers to incentive the purchases associated with online and/or mobile payments.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Online and/or mobile payments sometimes occur as a result of an offer provided to a customer by a merchant. For example, a merchant may provide their customers a discount offer (e.g., an offer to discount an amount off the price of a purchase), a credit offer (e.g., an offer to provide a credit that is redeemable with the merchant in response to a purchase, an offer to finance an amount of the price of the purchase), and/or a variety of other offers known in the art, and customers may be incentivized by that offer to make the online and/or mobile purchase. However, the use of such offers by merchants to incentivize purchases is speculative at best, as merchant have no way of estimating the success of different types of offers relative to each other, or what offer configuration of an offer will be the most successful relative to other offer configurations.

Thus, there is a need for an improved merchant offer system.

### BRIEF DESCRIPTION OF THE FIGURES

FIG. 1 is a flow chart illustrating an embodiment of a method for recommending offers to merchants;

FIG. 2 is a screen shot of an embodiment of a discount offer screen displayed by a customer device;

FIG. 3 is a screen shot of an embodiment of a credit offer screen displayed by a customer device;

FIG. 4 is a screen shot of an embodiment of a saved offers screen displayed by a customer device;

FIG. 5 is a screen shot of an embodiment of a merchant offer recommendation screen displayed by a merchant device;

FIG. 6 is a screen shot of an embodiment of an offer configuration screen displayed by a merchant device;

FIG. 7 is a schematic view illustrating an embodiment of a networked system;

FIG. 8 is a perspective view illustrating an embodiment of a customer device;

FIG. 9 is a schematic view illustrating an embodiment of a computer system; and

FIG. 10 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods for recommending offers to merchants for provision to their customers. As discussed above, merchants may provide their customers discount or credit offers to incentive those customers to make purchases, but the conventional provision of such offers is speculative at best, as merchants have no way of estimating the success of different types of offers relative to each other, or what offer configurations will be the most successful. However, in embodiments of the systems and methods described herein, a system provider (e.g., the payment service provider discussed below) assists in purchase transactions between merchants and customers, which allows to the system provider to determine subsets of a plurality of customers that are customers of each of the merchants. The system provider also assists in providing offers from merchants to customers, and stores customer offer data that details the results of the provision of offers by different merchants to different customers. This allows the system provider to retrieve a subset of the plurality of customers that are known to be customers of a particular merchant, and review the customer offer data to determine the results of providing offers to that subset of the customers. Those results may then be used to determine which offers are most likely to provide the highest amount of participation results by a merchant's subset of customers, and suggest to that merchant that they provide those offers to their customers. The determination of which offers are most likely to provide the highest amount of participation results by a merchant's subset of customers may include determining a type of offer (e.g., a discount offer) that may include a variety of different offer configurations (e.g., $10 off a $50 minimum purchase, $100 off a $300 minimum purchase, etc.), and then determining which configuration is likely to result in the higher amount of revenue for that merchant based on previous offers provided to that merchant's subset of customers.

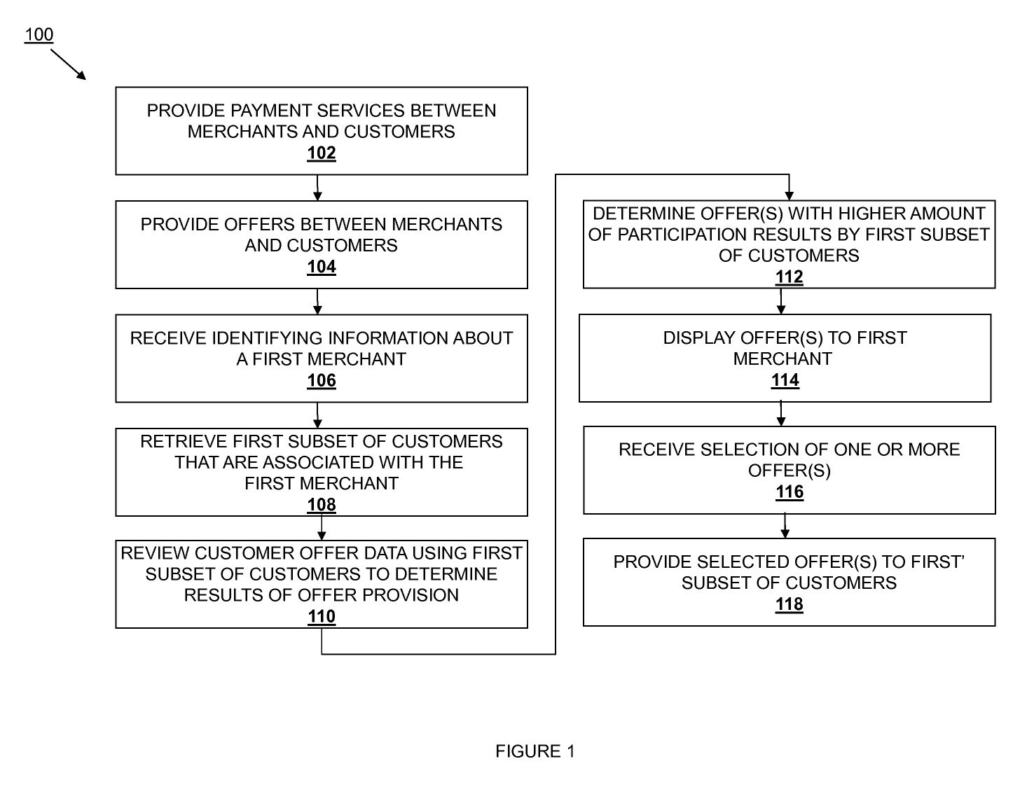

Referring now to FIG. 1, an embodiment of a method 100 for recommending offers to merchants is illustrated. In the embodiments discussed below, a payment service provider such as, for example, PayPal, Inc. of San Jose, Calif., is the system provider and operates a payment service provider device/system provider device to recommend offers to merchants for provision to their customers. However, one of skill in the art in possession of the present disclosure will recognize that a variety of other system providers such as, for example, credit providers, discount providers, and/or other offer providers will benefit from the teachings herein and thus fall within the scope of the present disclosure. Furthermore, while in the embodiments discussed below, systems providers are involved in purchase transactions and offer transactions between merchants and customers to create the databases that are utilized in the systems and methods of the present disclosure, other embodiments may include systems providers being provided access to such databases that are created by others such that those system providers do not provide payment services or offer services, but rather just the offer recommendation services described below.

The method 100 may begin at block 102 where payment services are provided between merchants and customers. In an embodiment, the payment service provider provides payment services between a plurality of different merchants and a plurality of different customers by operating a payment service provider device to facilitate purchase transactions between merchant devices operated by the merchants and customer devices operated by the customers. For example, each merchant may have a merchant payment service account with the payment service provider that may include at least one merchant financial account (e.g., provided by the payment service provider) and/or be linked to at least one merchant financial account (e.g., provided by a financial account provider), and those merchant payment service accounts may be stored in a database such as, for example, one or more merchant databases. In an embodiment, the merchant database may store, for each merchant, a merchant identification, a merchant type (e.g., based on the types of products and/or services the merchant offers), an average purchase amount (e.g., a “cart size”) of customers of the merchant (e.g., determined through the provision of payment services), a transaction history for the merchant (e.g., collected from the provision of payment services), merchant profile data (e.g., whether the merchant accepts credit, what types of payments (e.g., mobile, online, in-person) the merchant accepts, etc.) and/or a variety of other merchant information known in the art.

Similarly, each customer may have a customer payment service account with the payment service provider that may include at least one customer financial account (e.g., provided by the payment service provider) and/or be linked to at least one customer financial account (e.g., provided by a financial account provider), and those customer payment service accounts may be stored in a database such as, for example, one or more customer databases. In an embodiment, the customer database may store, for each customer, a customer identification, customer segmentation data (e.g., demographic information about each customer), a customer payment service account history (e.g., collected from the provision of payment services), and/or a variety of other customer information known in the art.

A customer and merchant may then transact purchases by determining one or more products and/or services (hereinafter “products”) for purchase, sending payment information that includes product details, purchase amount(s), merchant payment service account information, customer payment service account information, customer authorization information, and/or a variety of other purchase transaction information known in the art from the merchant device and/or the customer device to the payment service provider device. The payment service provider device then operates to transfer funds from one or more of the customer financial accounts to one or more of the merchant financial accounts to pay the merchant for the purchase of the product(s) by the customer.

The payment services provided by the payment service provider may occur online (e.g., a customer using a customer device such as a home computer to purchase product(s) from the merchant through a merchant website or application), in a mobile setting (e.g., a customer using a mobile customer device such as a phone to purchase product(s) from the merchant at a physical merchant location or any other physical location), in a traditional face-to-face setting (e.g., a customer using a customer payment device such as a payment service provider card or other payment card (e.g., a credit card) to purchase product(s) from the merchant at a physical merchant location), and/or in a variety of other manners known in the art.

Furthermore, the payment service provider may provide these payment services for a variety of different merchants and any of their customers. This allows the payment service provider to collect and store purchase transactions between a plurality of customers and a plurality of merchants that utilize their payment services in a database such as, for example, one or more transaction databases. In an embodiment, the transaction database may store, for each purchase transaction, merchant identifications, customer identifications, purchase times, purchase amounts, purchase locations, product details, and/or a variety of other purchase transaction information known in the art. In some embodiments, transaction information in the transaction database may be linked to information the merchant database and the customer database, and/or those databases may include the same information.

In an embodiment, the payment service provider device may analyze the purchase transaction information in the transaction database to associated subsets of the plurality of customers stored in the customer database with merchants stored in the merchant database. For example, a subset of the plurality of customers stored in the customer database may be determined to be customers of a particular merchant in the merchant database based on that subset of customers having performed one or more purchase transactions with that particular merchant. In some embodiments, the association of subsets of customers with a merchant may provide tiers of customers associated with a merchant based on transaction details between those customers and the merchant such as the number of transactions customers are involved in, the frequency of transactions by customers, the amount of transactions by customers, and/or other transaction information associated with each of the customers and that merchant. As such, a subset of the plurality of customers in the customer database may be determined to be customers of a particular merchant, and some of that subset of customers may be ranked as “top” customers (those with the most transactions, highest frequency of transactions, highest transaction amounts), while others of that subset of customers may be ranked as “medium”, “low”, and or other tiered designations that indicates those customers “value” to the merchant.

The method 100 then proceeds to block 104 where offers are provided between merchants and customers. In an embodiment, the payment service provider may operate the payment service provider device to provide offers from a plurality of different merchants to a plurality of customers. In the embodiments discussed below, the offers provided from merchants to customers are described as discount offers and credit offers. However, one of skill in the art in possession of the present disclosure will recognize that a wide variety of other types of offers will benefit from the present disclosure and thus fall within its scope. The offers provided from the merchants to the customer at block 104 may have been suggested by the systems and methods of the present disclosure, discussed in further detail below. In some embodiments, the offers may have been created by the merchant by selecting an offer type (e.g., a discount offer type, a credit offer type, etc.) and providing or accepting an offer configuration (e.g., discount details such as $10 off a $50 purchase, credit details such as $100 in credit at a particular interest rate, etc.). In other embodiments, the offers may have been created by the payment service provider, a credit provider, or another party by selecting the offer type and offer configuration.

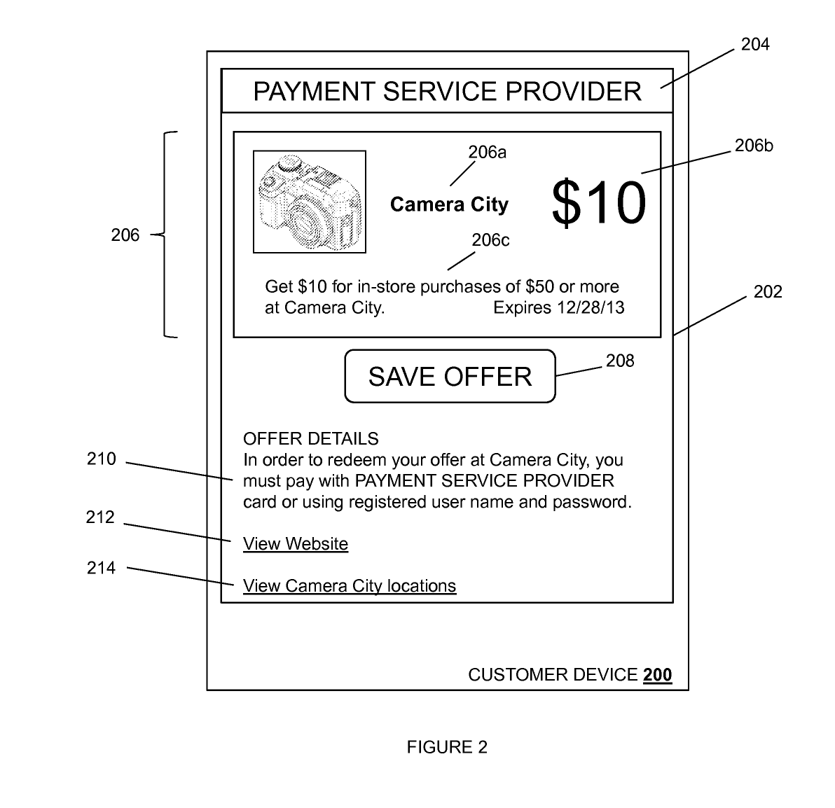

Referring now to FIG. 2, an embodiment of a customer device 200 is illustrated that includes a display device 202 displaying a discount offer screen 204 for a discount offer that may be provided at block 104. In the illustrated embodiment, the discount offer screen 204 is displaying a discount offer provided by a merchant (e.g., “Camera City” in the illustrated embodiment) to a customer having the customer device 200, with the assistance of the payment service provider. However, the discount offer may be provided by the merchant to the customer in a variety of manners (e.g., without assistance from the payment service provider) while remaining within the scope of the present disclosure. The discount offer screen 204 includes an offer summary section 206 that includes a merchant identification 206a, a discount amount 206b, and a discount detail summary 206c that explains that the discount amount is available for in-store purchases exceeding a minimum amount, and explains when the discount offer expires. The discount offer screen 204 also includes a save offer button 208, additional discount offer details 210, a merchant website link 212 to the website of the merchant providing the discount offer, and a merchant physical location link 214 that allows the customer to retrieve a map to one or more physical locations of the merchant offering the discount. The discount offer illustrated in FIG. 2 is an example of a “closed loop offer” that is provided to the customer through their customer device 200, and allows the customer to save the discount offer (e.g., by selecting the save offer button 208) to their customer payment service account (e.g., a digital wallet associated with that account) and be alerted when the discount offer is about to expire, have the discount offer automatically applied at the time of a purchase from the merchant offering the discount offer, and/or provides a variety of other closed loop offer benefits known in the art. However, as discussed above, a variety of discount offers other than closed loop offers will fall within the scope of the present disclosure.

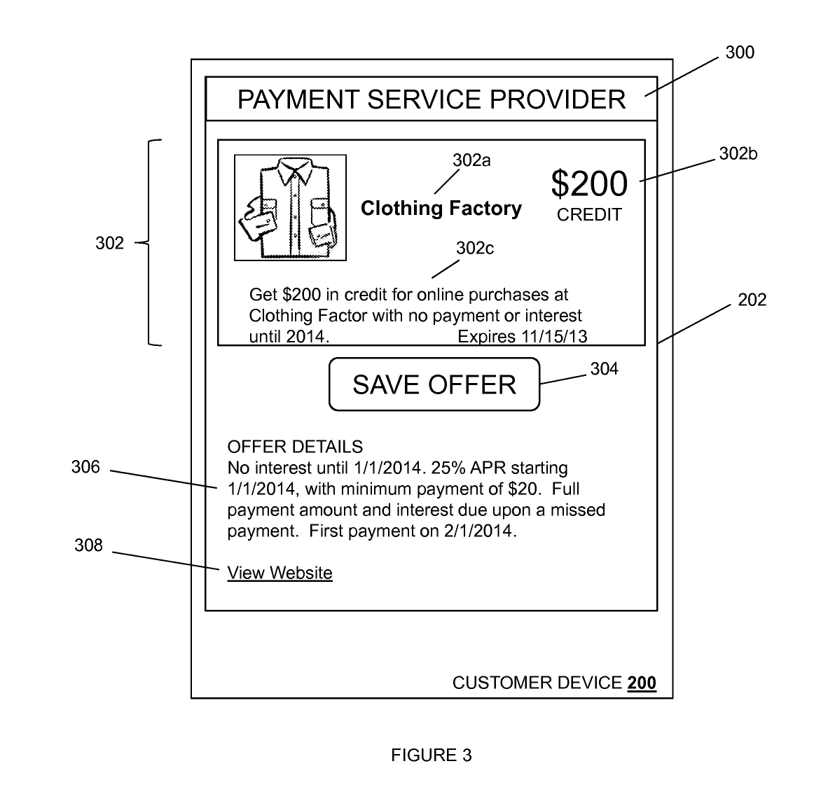

Referring now to FIG. 3, an embodiment of the customer device 200 is illustrated that includes the display device 202 displaying a credit offer screen 300 for a credit offer that may be provided at block 104. In the illustrated embodiment, the credit offer screen 300 is displaying a credit offer provided by a merchant (e.g., “Clothing Factory” in the illustrated embodiment) to a customer having the customer device 200, with the assistance of the payment service provider. However, the credit offer may be provided by the merchant to the customer in a variety of manners (e.g., without assistance from the payment service provider) while remaining within the scope of the present disclosure. The credit offer screen 300 includes an offer summary section 302 that includes a merchant identification 302a, a credit amount 302b, and a credit detail summary 302c that explains that the credit amount is available for online purchases with no payments or interest until 2014, and explains when the credit offer expires. The credit offer screen 300 also includes a save offer button 304, additional credit offer details 306, and a merchant website link 308 to the website of the merchant providing the discount offer. The credit offer illustrated in FIG. 3 is another example of a “closed loop offer” that is provided to the customer through their customer device 200, and allows the customer to save the credit offer (e.g., by selecting the save offer button 304) to their customer payment service account (e.g., a digital wallet associated with that account) and be alerted when the credit offer is about to expire, have the credit offer automatically applied at the time of a purchase from the merchant offering the credit offer, etc. However, as discussed above, a variety of credit offers other that closed loop offers will fall within the scope of the present disclosure.

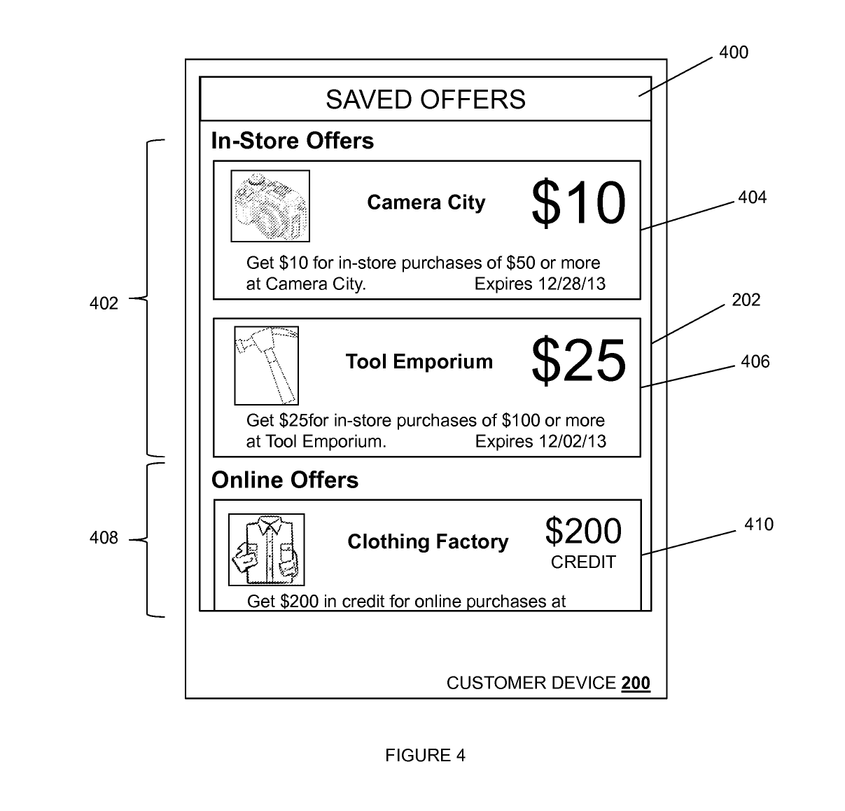

Referring now to FIG. 4, an embodiment of the customer device 200 is illustrated that includes the display device 202 displaying a saved offers screen 400 for a plurality of offers that may be provided at block 104. As discussed above, in some embodiments, the customer may save offers provided by merchants in their customer payment service account (e.g., in an electronic wallet on the customer device 200), and those saved offers may be reviewed on the saved offers screen 400. In the illustrated embodiment, the saved offers screen 400 includes an in-store offers section 402 that includes offers 404 and 406 from merchants that must be redeemed at a merchant physical location, along with an online offers section 408 that includes an offer 410 from a merchant that must be redeemed at a merchant website. In the illustrated embodiment, the saved offer screen 400 allows a customer to review closed loop offers that have been saved by that customer. However, offers other than closed loop offers may be provided by the merchant to the customer and used without being saved to a customer payment service account, and the use of those offers may be tracked by the payment service provider, as discussed below.

In an embodiment, the provision of offers to customers may generate customer offer data that is stored in one or more databases, regardless of whether the customer participates in those offers. For example, discount offers provided by merchants to customers may generate customer offer data that is stored in one or more discount offer database that includes, for each discount offer, a discount offer identification, a merchant identification identifying the merchant providing the discount offer, discount offer configuration details, an eligible customer identification that identifies the customers eligible to redeem the discount offer, targeted customers (e.g., an identification of customers to which the offer will be provided), a redeeming customer identification that identifies the customers that have redeemed the discount offer, a discount offer value, a discount offer minimum, a discount offer start date, and discount offer expiration, a discount offer size (e.g., a number of customers to which the discount offer will be provided), a discount offer timing (e.g., a time period in which the discount offer will be provided to customers), a channel eligibility (e.g., an indication of where the offer will be accepted (e.g., online, mobile, in-store, etc.), and/or a variety of other discount offer information known in the art. In another example, credit offers provided by merchants to customers may generate customer offer data that is stored in a credit offer database that includes, for each credit offer, a credit offer identification, a merchant identification identifying the merchant providing the credit offer, credit offer configuration details such as an eligible customer identification that identifies the customers eligible to redeem the credit offer, a redeeming customer identification that identifies the customers that have redeemed the credit offer, a credit offer limit, a credit offer type (e.g., installment), an activation date, an interest rate, and/or a variety of other credit offer information known in the art. In some embodiments, customer offer data in the offer database(s) may be linked to information in the transaction database, merchant database, and/or the customer database, and/or those databases may include the same information.

At block 104, customers may use offers provided by merchants to purchase products from those merchants, and those offer transactions may also generate customer offer data that is stored in the transaction database and offer database(s), or linked between those databases along with the merchant database and customer database. In an embodiment, the use of an offer by a customer with a merchant may result in customer offer data being added to one or more databases. For example, the use of a credit offer by a customer may involve determining the eligibility of the customer for credit, and that eligibility may then be added as customer offer data to the customer database for that customer. In another example, any offers used by a customer may be associated with that customer as customer offer data in the customer database. In another example, any merchant with whom a customer uses an offer may be associated with that customer as customer offer data in the customer database. In another example, any offers provided by a merchant may be associated with that merchant as customer offer data in the merchant database.

While a few examples of the collection of data by the payment service provider through the performance of payment services and offer provision has been described, one of skill in the art will recognize that the payment service provider may capture and store all details associated with the provision of payment services (e.g., payment transaction conducted between merchants and customers) and offers (e.g., the provision of offers to customers, the use of offers by customers to make purchases, the failure of customers to use offers received from merchants, etc.) Using the transaction database, customer database, merchant database, and offer database(s), the payment service provider may link information collected and stored during the provision of payment services and offers according to blocks 102 and 104. As discussed below, this allows the payment service provider to associate customers with merchants, customers with a customer type (e.g., by purchasing habits, demographic information, etc.), merchants with a merchant type, transactions with time periods, and/or any other association that may be used to determine which offer types are most likely to be participated in by a subset of the plurality of customers in the customer database, which offer configurations of an offer are most likely to be participated in by a subset of the plurality of customers in the customer database, and/or make any other determinations that allow for the prediction of which offer(s) of a plurality of offers are most likely to be successful with a subset of the plurality of customers. As discussed above, in embodiments where the system provider device is provided by an entity other than a payment service provider or offer provider, the transaction database, customer database, merchant database, and offer database(s) may be accessible by the system provider device while not being generated or managed by the system provider.

The method 100 then proceeds to block 106 where identifying information about a first merchant is received. In an embodiment, the payment service provider device receives identifying information about a first merchant. For example, the payment service provider device may receive the identifying information about the first merchant from a user of the payment service provider device (e.g., an employee or representative of the payment service provider) that is looking for offers to recommend to the merchant. In another example, the payment service provider device may operate to identify merchants automatically (e.g., receive the identifying information about the first merchant based on a schedule, at random, etc.) and determine offers to recommend to those merchants. In another example, a first merchant may provide the identifying information about themselves over the network (e.g., using a merchant device) to the payment service provider device. While a few examples have been provided, the payment service provider device may receive or determine the identifying information about the first merchant in a variety of manners while remaining within the scope of the present disclosure. In one embodiment of block 106, the payment service provider device uses the identifying information about the first merchant to find the first merchant in the merchant database. In another embodiment of block 106, the first merchant may not be in the merchant database, but the identifying information about the first merchant may include a merchant type for the first merchant, a plurality of customers associated with the first merchant, a customer type associated with the first merchant, and/or a variety of other first merchant information known in the art that allows the payment service provider device to estimate a subset of customers for the first merchant so that an analysis may be conducted as to how that estimated subset of customers would react to different offers.

The method 100 then proceeds to block 108 where a first subset of customers is retrieved that are associated with the first merchant. In an embodiment, the payment service provider device uses the first merchant determined from the identifying information received at block 106 to retrieve a first subset of the plurality of customers in the customer database that are associated with that first merchant. As discussed above, a subset of the plurality of customers in the customer database may be associated with a particular merchant based on the determination that that subset of customers are customers of that particular merchant due to that subset of customers making purchases from that merchant at blocks 102 and/or 104.

In one example, using the first merchant in the merchant database that was identified by the identifying information received at block 106, the payment service provider device may retrieve the customers of that first merchant (i.e., a first subset of the plurality of customers in the customer database). Thus, based on the associations between the first merchant in the merchant database and customers in the customer database, a first subset of the plurality of customers in the customer database are determined by the payment service provider device to be customers of the first merchant.

In another example, using the identifying information about the first merchant that is not in the merchant database, the payment service provider device may retrieve a first subset of customers that are customers of merchants that are similar to the first merchant (e.g., based on those merchants having a merchant type that is the same as or similar to the first merchant). Thus, based on the associations between the customers in the customer database and one or more merchants in the merchant database, a first subset of the plurality of customers in the customer database are determined by the payment service provider device to be customers of the merchants that are the same as or similar to the first merchant.

The method 100 then proceeds to block 110 where customer offer data is reviewed using the first subset of customers to determine results from providing previous offers to that first subset of customers. In an embodiment, the payment service provider device uses the first subset of the plurality of customers in the customer database determined in block 108 to review the customer offer data associated with the customers in that first subset in the offer database(s), and determines the results of providing one or more offers to each of the customers in the first subset. For example, for each customer in the first subset determined at block 108, the payment service provider device may review each offer provided to that customer and determine the type of offer that was provided, the offer configuration of that offer, whether that customer participated in that offer or not, and or any of information generated during the provision of that offer to that customer. In some embodiments, the payment service provider device may review offers provided by any merchant to each of the customers in the first subset. In some embodiments, the payment service provider may filter offers provided to each of the customers in the first subset such that only offers provided by merchants that are the same merchant type or of a similar merchant type to the first merchant are reviewed. In an embodiment, the offer information determined by reviewing the customer offer data associated with the first subset of customers may be saved or otherwise marked, and may provide aggregate numbers for the number of offers provided to the first subset of customers, the types of different offers provided to the first subset of customers, the offer configurations of offers provided to the first subset of customers, the participation results by the first subset of customers in offers provided to them, and/or a variety of other aggregate offer information that describes the results of providing previous offers to the first subset of customers.

The method 100 then proceeds to block 112 where offer(s) are determined that have the highest amount of participation results by the first subset of customers. In an embodiment, the payment service provider device analyzes the offer information for the first subset of customers that was determined from reviewing the customer offer data at block 110 to determine one or more offers with a higher amount of participation results relative to other offers that have been offered to the first subset of customers. Participation results associated with offers provided to customers may be defined by the payment service provider, a merchant, or other entity to measure any offer result metric that the payment service provider, merchant, or other entity would like to optimize, increase, or otherwise focus on in determining which offers to provide to customers. In one example, participation results for a particular offer may be defined as a percentage of the first subset of customers that participate in that offer, and at block 112, the offer(s) with the highest percentage of the first subset of customers participating in them will be determined. In another example, participation results for a particular offer may be defined as a total number of the first subset of customers that participate in that offer, and at block 112, the offer(s) with the highest number of the first subset of customers participating in them will be determined. In another example, participation results for a particular offer may be defined as a total revenue generated from the first subset of customers in providing that offer, and at block 112, the offer(s) with the highest revenue generated from the first subset of customers in providing that offer will be determined. While a few examples have been provided, one of skill in the art in possession of the present disclosure will recognize that participation results may be defined in a variety of suitable manners to determine which offers previously provided to the first subset of customers have been most successful.

In some embodiments of block 112, the customer offer data, results of offer provision, and participation results determined for the offer(s) at blocks 110 and 112 may be used to determine an estimated benefit to the first merchant. For example, using a first offer from the offer(s) determined at block 112, the participation results that estimate the total number of the first subset of customers that will participate in the first offer, and the offer configuration details that detail the amount of each offer, the payment service provider may calculate an amount of additional revenue that will result from the first merchant providing the first offer to the first subset of customers. In another example, using a first offer from the offer(s) determined at block 112, the participation results that estimate the total number of the first subset of customers that will participate in the first offer, and the offer configuration details that detail the amount of each offer, the payment service provider may calculate an average purchase amount from each participating customer that will result from the first merchant providing the first offer to the first subset of customers. Estimated benefits to merchants may be refined by retrieving merchant information from the merchant database such as, for example, profit margins, advertising costs, and/or a variety of other information known in the art that would allow the payment service provider device to estimate how much revenue an offer would generate if provided by the first merchant to the first subset of customers. Similarly, estimated benefits determined for the first merchant may include a total number of customers that will participate in the offer, a percentage of known customers that will participate in the offer, a projected increase in sales relative to another time period for the merchant, a total purchase value of providing the offer, a number of new customers that will participate in the offer, and/or a variety of other estimated benefits known in the art.

In some embodiments, the review of the customer offer data at block 110 may result in the payment service provider determining that a first subset of the offers that have been previously provided to the first subset of customers have a common offer type (e.g., they are all discount offers), and at least some of the offers in that first subset of offers have different offer configurations (e.g., a first discount offer has a first discount offer configuration of $10 off $50, a second discount offer has a second discount offer configuration of $50 off $200, a third discount offer has a third discount offer configuration of $100 off $500, and so on.) At block 112, the payment service provider device may determine which of the offer configurations of the first subset of offers having the common offer type has the higher amount of participation results. For example, the payment service provider device may determine that the highest number of the first subset of customers has participated in discount offers with an offer configuration of $10 off $50, while the highest revenue from the first subset of customers has been generated by providing the first subset of customers a discount offer with an offer configuration of $50 off $200 (e.g., a discount offer that may result in less customer participation but higher revenue.) That information may then be used to determine which of the offer configurations provides an offer with the highest amount of participation results, or which offer configuration to suggest to the merchant.

In some embodiments, an offer determined at block 112 may be determined for a merchant that is not currently providing any offers to its customers (or that has never provided offers to its customers.) In some embodiments, an offer determined at block 112 may have an offer type and may be determined for a merchant that is not currently providing any offers of that offer type to its customers (or that has never provided offers of that offer type to its customers.) In some embodiments, the merchant for which the offer is determined at block 112 may be providing an offer having an offer type to its customers, and the offer being determined at block 112 may have the same offer type but a different offer configuration. As such, the offer(s) determined at block 112 may be used to recommend new offers or offer types to merchants, or may be used to recommend offer configuration changes for existing offers being provided by merchants.

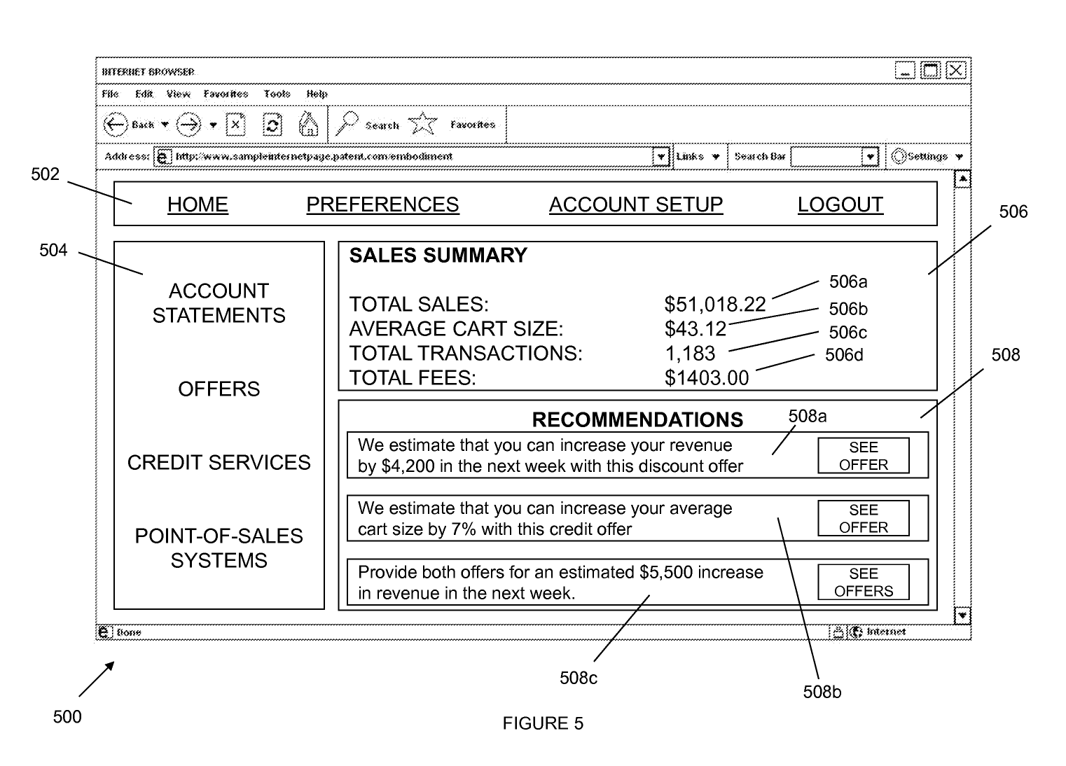

Referring now to FIG. 5, the method 100 then proceeds to block 114 where offer(s) are displayed to the first merchant. In an embodiment, the payment service provider device sends the offer(s) determined at block 112 over a network to a merchant device. FIG. 5 illustrates an embodiment of a merchant offer recommendation screen 500 displayed on a merchant device. The merchant offer recommendation screen 500 includes a navigation section 502 that allows the merchant to navigate through their merchant payment service account, and a services section 504 that allows the merchant to navigate through different services provided as part of the payment services provided by the payment service provider. The merchant offer recommendation screen 500 also includes a merchant payment service account summary section 508 that provides a summary of sales by the merchant to its customers (e.g., over a month, a year-to-date, etc.), including a total sales amount 506a, an average purchase amount by each of those customers 506b, a total number of transactions 506c, and a total amount of fees 506d.

The merchant offer recommendation screen 500 also includes an offer recommendation section 508 that, in the illustrated embodiment, includes a discount offer recommendation 508a, a credit offer recommendation 508b, and a combined offer recommendation 508c. In the illustrated embodiment, the discount offer recommendation 508a may be one of the offers determined at block 112, includes an amount of additional revenue estimated for the merchant in providing that offer to its customers (e.g., “$4,200 in the next week”), and a See Offer button that the merchant may select to view the offer configuration. In the illustrated embodiment, the credit offer recommendation 508b may be one of the offers determined at block 112, includes an estimated increase in the average purchase amount by the merchant's customers in providing that offer to its customers (e.g., “increase your average cart size by 7%”), and a See Offer button that the merchant may select to view the offer configuration. In the illustrated embodiment, the combined offer recommendation 508c includes both of the discount offer recommendation 508a and the credit offer recommendation 508b, includes an amount of additional revenue estimated for the merchant in providing those offers to its customers (e.g., “$5,500 in the next week”), and a See Offers button that the merchant may select to view the configurations of the offers. One of skill in the art will recognize that while a few examples of recommended offers have been illustrated and described as being provided for display to the merchant, any number of offers may be provided for display to the merchant while remaining within the scope of the present disclosure.

The combined offer recommendation 508b illustrates how the payment service provider device may operate to determine, model, or otherwise predict the additive effects of combing offers (e.g., a discount offer and a credit offer) together. In some embodiments, the payment service provider device may predict the aggregated impact of the estimated increase in number of orders that will result from providing a discount offer and the estimated increase in average purchase amount that will result from providing a credit offer. For example, such determinations, modeling, or otherwise predicting for discount offers may include reviewing a customer base (e.g., the first subset of customers) over a period of time, identifying which of those customers have previously participated in a discount offer, and determining whether that participation resulted in a purchase transaction that is above or below the average purchase transaction for the merchant. The payment service provider device may then run scenarios based on the merchant to determine, model, or otherwise predict how various discount offers or discount offer configurations would perform based on the likelihood of the offer to generate purchases from new customers or higher purchase transactions from existing customers. In another example, such determinations, modeling, or otherwise predicting for credit offers may include reviewing a customer base (e.g., the first subset of customers) over a period of time, identifying which of those customers are eligible for credit products, determining the merchants average purchase amount, and comparing that average purchase amount to other merchants of a similar merchant type. The payment service provider device may then run scenarios based on the merchant to determine, model, or otherwise predict how various credit offers or credit offer configurations would perform based on their history in enticing customers to spend more on purchases.

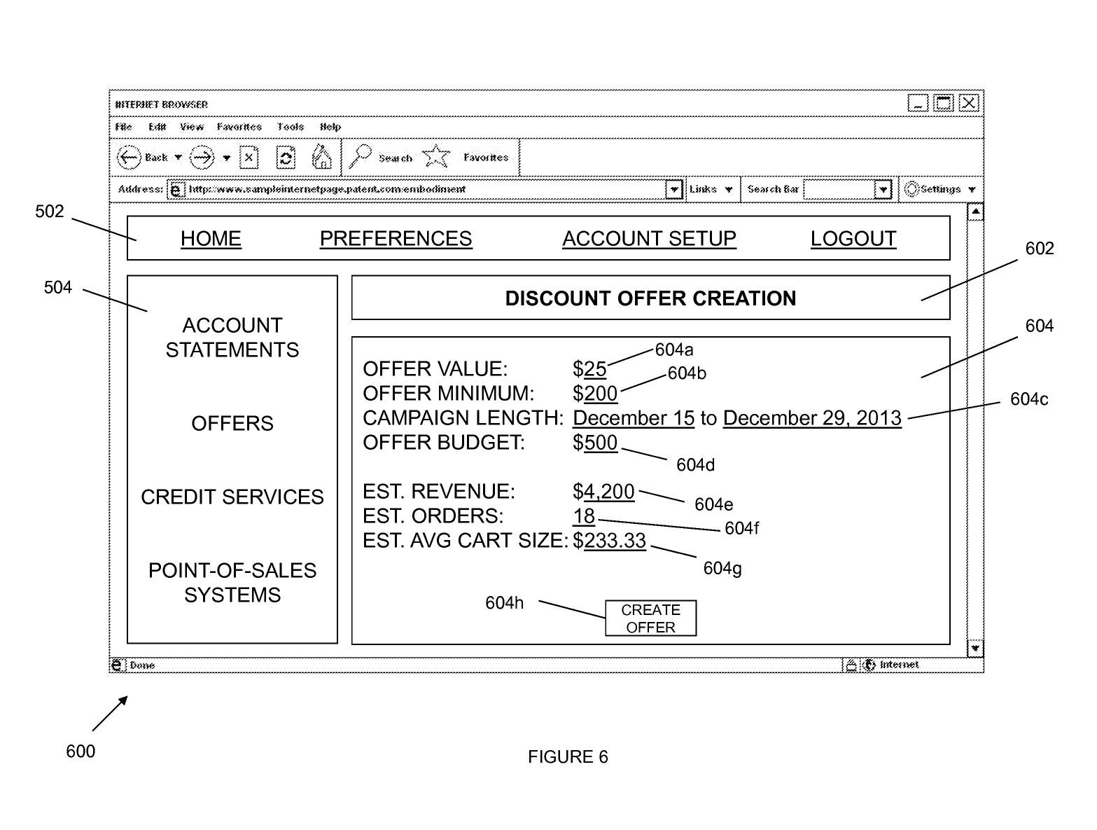

Referring now to FIG. 6, the method 100 then proceeds to block 116 where a selection of one or more offers is received. In an embodiment, the merchant may select a recommended offer or offers from the merchant offer recommendation screen 500, and the payment service provider device may then provide the offer configurations of the selected offer(s) over a network to a merchant device for display to the merchant. FIG. 6 illustrates an embodiment of a merchant offer configuration screen 600 displayed on a merchant device, which is similar to the merchant offer recommendation screen 500 and includes the navigation section 502 and the services section 504. However, in response to a selection of the See Offer button in the discount offer recommendation 508a on merchant offer recommendation screen 500 in the illustrated embodiment, the payment service provider device may provide a discount offer creation section that includes a discount offer configuration section 604 for the discount offer.

The discount offer configuration section 604 includes discount offer configuration details for the discount offer determined at block 112, including in the illustrated embodiment an offer value 604a for the discount offer (e.g., $25 off), an offer minimum 604b for the discount offer (e.g., a minimum purchase of $200), campaign length 604c for the discount offer (e.g., two weeks at the end of December), and an offer budget 604d for the discount offer (e.g., $500). For example, any of all of the offer value 604a, the offer minimum 604b, the campaign length 604c, and the offer budget $500 may be the offer configuration details for the offer determined at block 112 that were determined to have the highest amount of participation results for the first subset of customers that were determined to be customers of the merchant. The discount offer configuration section 604 also includes estimated benefits to the merchant, including in the illustrated embodiment an estimated revenue 604e that will result from the discount offer (e.g., $4,200), an estimated number of orders 604f that will result from the discount offer (e.g., 18 orders), and an estimated average purchase amount 604g that will result from the discount offer (e.g., $233.33).

Each of the discount offer configuration details for the discount offer (e.g., the offer value 604a, the offer minimum 604b, and the campaign length 604c) may be editable by the merchant. In response to the merchant editing the discount offer configuration details, the estimated benefits to the merchant (e.g., the estimated revenue 604e, the estimated orders 604f, and/or the average cart size 604g) may be adjusted by the payment service provider device based on the customer offer data associated with the first subset of customers. For example, in response to the merchant editing the offer minimum 604b (e.g., from $200 to $300), the payment service provider device may determine that the first subset of customers are less likely to participate in the offer and reduce the estimated number of orders 604f and the estimated revenue 604e, while increasing the estimated average purchase amount 604g.

The discount offer configuration section 604 also includes a Create Offer button 604h. A selection of the Create Offer button 604h by the merchant is sent to the payment service provider device and causes the method 100 to proceed to block 118 where the selected offer(s) are provided to the first subset of customers. In an embodiment, upon receiving the selection of the Create Offer button 604h, the payment service provider device sends the discount offer over the network to the first subset of customer such that that discount offer may be displayed to some or all of that first subset of customers on their customers devices substantially as illustrated in FIGS. 2 and 3. For example, the offer provided to the customers at block 118 may be targeted to particular customers in the first subset, sent to all of the customers in the first subset, sent to customers that are similar to customers in the first subset but that have not previously been involved in a purchase transaction with the first merchant (e.g., new customers), and/or provided to a variety of other existing and/or new customers using methods known in the art. While a specific example of the selection of a recommended discount offer by the merchant and its provision to the customer of the merchant has been illustrated and described, one of skill in the art in possession of the present disclosure will recognize that recommended credit offers, or any other offer known in the art, may be selected by merchants and provided to the customers in substantially the same manner as described above.

Thus, systems and methods for recommending offers to merchants for provision to their customers have been described that use the results of the provision of previous offers to those customers (or customers of similar merchants) to predict how a subset of those customers will respond to offers from a merchant they are associated with, and then recommend to that merchant the offers that have the highest amount of participation results from that first subset of customers. The systems and methods of the present disclosure leverage customer offer data collected from transactions between a variety of different merchants and a variety of different customers in response to those merchant providing offers to those customers to determine which offers would be most successful if provided by a particular merchant to their customers. The merchant may also be provided estimated benefits in providing offers such as an amount of revenue and customer participation that will result from providing an offer to allow the benefit of providing the offer to be quantified to the merchant.

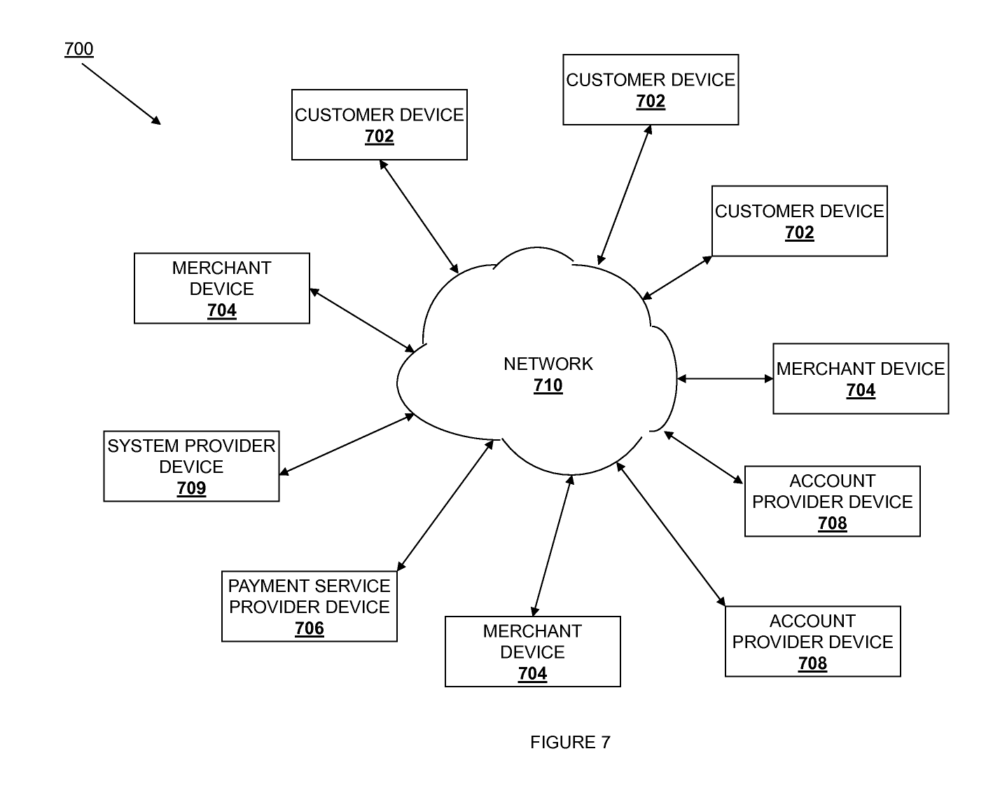

Referring now to FIG. 7, an embodiment of a network-based system 700 for implementing one or more processes described herein is illustrated. As shown, network-based system 700 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 7 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 700 illustrated in FIG. 7 includes a plurality of customer devices 702, a plurality of merchant devices 704, a payment service provider device 706, a plurality of account holder devices 708, and/or a system provider device 709 in communication over a network 710. Any of the customer devices 702 may be the customer device 200, discussed above. The merchant devices 604 may be the merchant devices discussed above and may be operated by the merchants discussed above. The payment service provider device 706 may be the payment service provider devices discussed above and may be operated by a payment service provider such as, for example, PayPal Inc. of San Jose, Calif. The account provider devices 708 may be the account provider devices discussed above and may be operated by the financial account providers discussed above such as, for example, credit card account providers, bank account providers, savings account providers, and a variety of other account providers known in the art. The system provider device 709 may be the system provider devices discussed above and may be operated by the system providers discussed above.

The customer devices 702, merchant devices 704, a payment service provider device 706, account holder devices 708, and/or system provider device 709 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 700, and/or accessible over the network 710.

The network 710 may be implemented as a single network or a combination of multiple networks. For example, in various embodiments, the network 710 may include the Internet and/or one or more intranets, landline networks, wireless networks, and/or other appropriate types of networks.

The customer devices 702 may be implemented using any appropriate combination of hardware and/or software configured for wired and/or wireless communication over network 710. For example, in one embodiment, the customer devices 702 may be implemented as a personal computers of users in communication with the Internet. In other embodiments, the customer devices 702 may be smart phones, personal digital assistants (PDAs), laptop computers, and/or other types of computing devices.

The customer devices 702 may include one or more browser applications which may be used, for example, to provide a convenient interface to permit the customer to browse information available over the network 710. For example, in one embodiment, the browser application may be implemented as a web browser configured to view information available over the Internet.

The customer devices 702 may also include one or more toolbar applications which may be used, for example, to provide customer-side processing for performing desired tasks in response to operations selected by the customer. In one embodiment, the toolbar application may display a user interface in connection with the browser application.

The customer devices 702 may further include other applications as may be desired in particular embodiments to provide desired features to the customer devices 702. In particular, the other applications may include a payment application for payments assisted by the payment service provider through the payment service provider device 706. The other applications may also include security applications for implementing user-side security features, programmatic user applications for interfacing with appropriate application programming interfaces (APIs) over the network 710, or other types of applications. Email and/or text applications may also be included, which allow the customer to send and receive emails and/or text messages through the network 710. The customer devices 702 include one or more customer and/or device identifiers which may be implemented, for example, as operating system registry entries, cookies associated with the browser application, identifiers associated with hardware of the customer devices 702, or other appropriate identifiers, such as a phone number. In one embodiment, the customer identifier may be used by the merchant devices 704, payment service provider device 706, account provider devices 708, and/or system provider device 709 to associate the customer with a particular account as further described herein.

The merchant devices 704 may be maintained, for example, by a conventional or on-line merchant, conventional or digital goods seller, individual seller, and/or application developer offering various products and/or services in exchange for payment to be received conventionally or over the network 710. In this regard, the merchant devices 704 may include a database identifying available products and/or services (e.g., collectively referred to as items) which may be made available for viewing and purchase by the customers.

The merchant devices 704 also include a checkout application which may be configured to facilitate the purchase by the payer of items. The checkout application may be configured to accept payment information from the customer through the customer devices 702, the account providers through the account provider devices 708, from the payment service provider through the payment service provider device 706, and/or from the system provider through the system provider device 709 over the network 710.

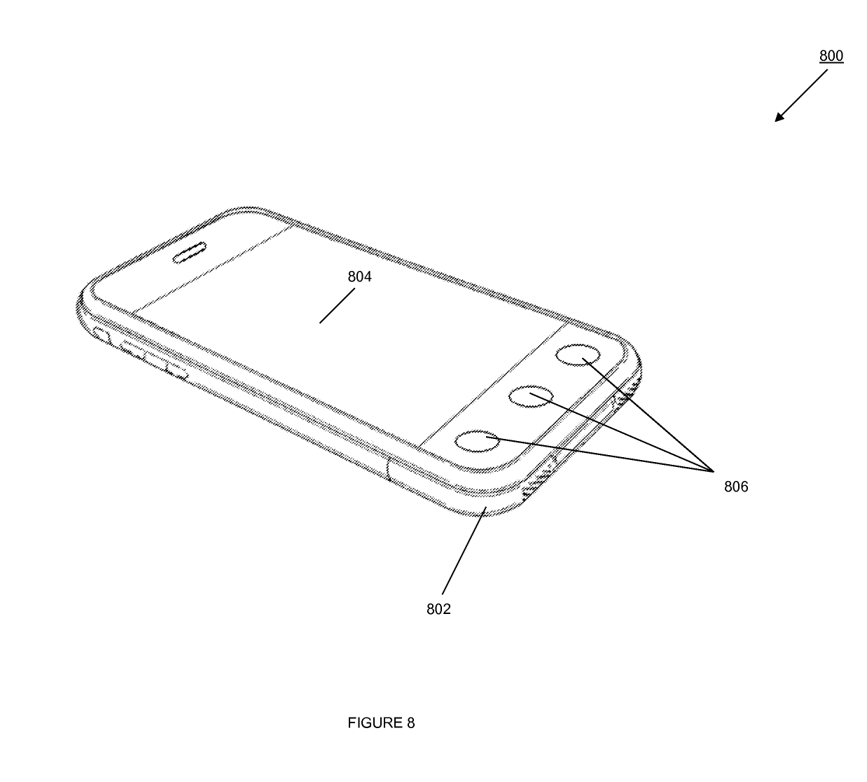

Referring now to FIG. 8, an embodiment of a customer device 800 is illustrated. The customer device 800 may be the customer devices 200 and/or 702. The customer device 800 includes a chassis 802 having a display 804 and an input device including the display 804 and a plurality of input buttons 806. One of skill in the art will recognize that the customer device 800 is a portable or mobile phone including a touch screen input device and a plurality of input buttons that allow the functionality discussed above with reference to the method 100. However, a variety of other portable/mobile payer devices and/or desktop payer devices may be used in the method 100 without departing from the scope of the present disclosure.

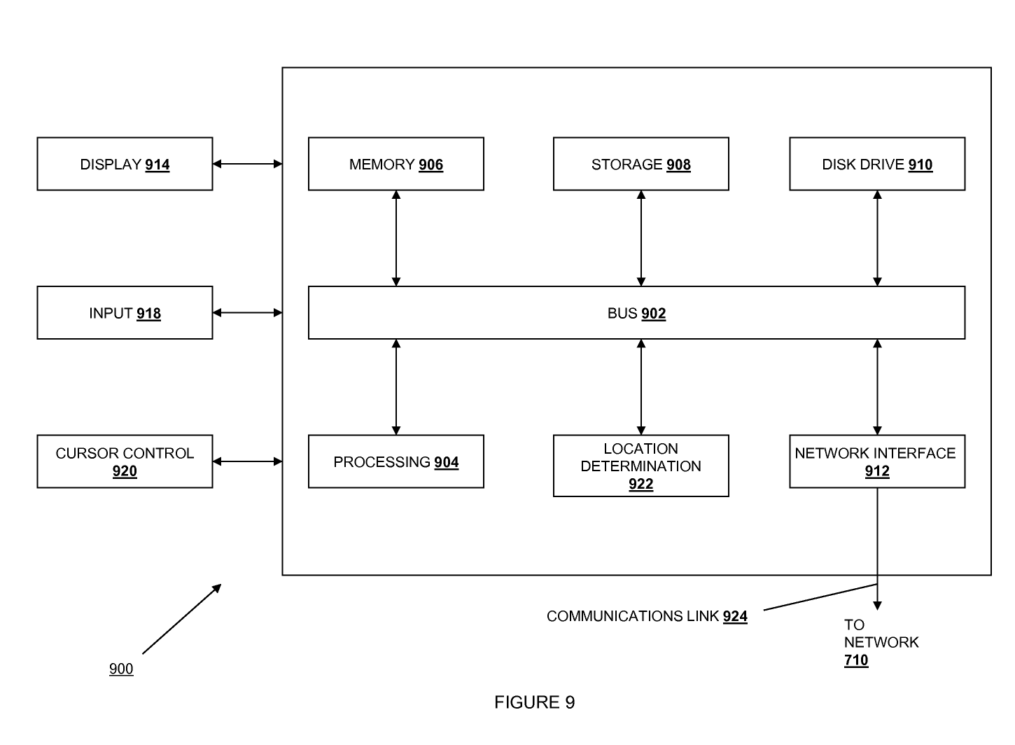

Referring now to FIG. 9, an embodiment of a computer system 900 suitable for implementing, for example, the customer devices 200, 702, and/or 800, the merchant devices 704, the payment service provider device 706, the account provider devices 708, and/or the system provider device 709 is illustrated. It should be appreciated that other devices utilized by the customers, merchants, payment service providers, account providers, and/or system providers in the offer recommendation system discussed above may be implemented as the computer system 900 in a manner as follows.

In accordance with various embodiments of the present disclosure, computer system 900, such as a computer and/or a network server, includes a bus 902 or other communication mechanism for communicating information, which interconnects subsystems and components, such as a processing component 904 (e.g., processor, micro-controller, digital signal processor (DSP), etc.), a system memory component 906 (e.g., RAM), a static storage component 908 (e.g., ROM), a disk drive component 910 (e.g., magnetic or optical), a network interface component 912 (e.g., modem or Ethernet card), a display component 914 (e.g., CRT or LCD), an input component 918 (e.g., keyboard, keypad, or virtual keyboard), a cursor control component 920 (e.g., mouse, pointer, or trackball), and/or a location determination component 922 (e.g., a Global Positioning System (GPS) device as illustrated, a cell tower triangulation device, and/or a variety of other location determination devices known in the art.) In one implementation, the disk drive component 910 may comprise a database having one or more disk drive components.

In accordance with embodiments of the present disclosure, the computer system 900 performs specific operations by the processor 904 executing one or more sequences of instructions contained in the memory component 906, such as described herein with respect to the customer devices 200, 702, and 800, the merchant device(s) 704, the payment service provider device 706, the account provider device(s) 708, and/or the system provider device 709. Such instructions may be read into the system memory component 906 from another computer readable medium, such as the static storage component 908 or the disk drive component 910. In other embodiments, hard-wired circuitry may be used in place of or in combination with software instructions to implement the present disclosure.

Logic may be encoded in a computer readable medium, which may refer to any medium that participates in providing instructions to the processor 904 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 910, volatile media includes dynamic memory, such as the system memory component 906, and transmission media includes coaxial cables, copper wire, and fiber optics, including wires that comprise the bus 902. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 900. In various other embodiments of the present disclosure, a plurality of the computer systems 900 coupled by a communication link 924 to the network 710 (e.g., such as a LAN, WLAN, PTSN, and/or various other wired or wireless networks, including telecommunications, mobile, and cellular phone networks) may perform instruction sequences to practice the present disclosure in coordination with one another.

The computer system 900 may transmit and receive messages, data, information and instructions, including one or more programs (i.e., application code) through the communication link 924 and the network interface component 912. The network interface component 912 may include an antenna, either separate or integrated, to enable transmission and reception via the communication link 924. Received program code may be executed by processor 904 as received and/or stored in disk drive component 910 or some other non-volatile storage component for execution.

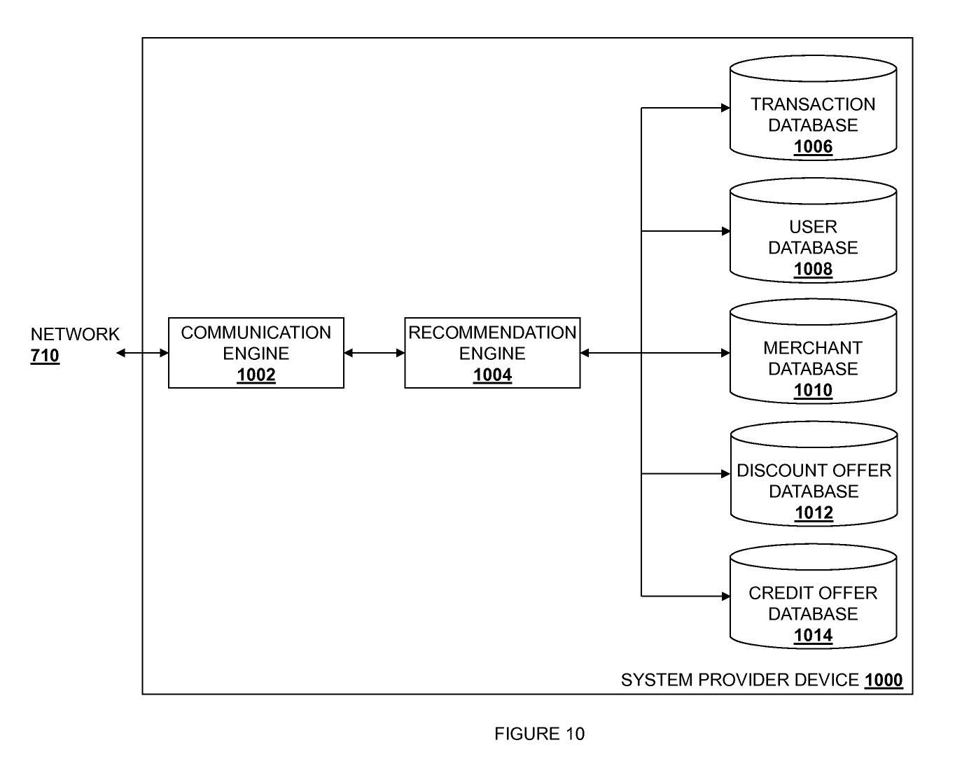

Referring now to FIGS. 10, an embodiment of a system provider device 1000 is illustrated. In an embodiment, the device 1000 may be the payment service provider device 706 and/or the system provider device 709. The device 1000 includes a communication engine 1002 that is coupled to the network 710 and to a recommendation engine 1004 that is coupled to a transaction database 1006, a user database 1008, a merchant database 1010, a discount offer database 1012, and a credit offer database 1014. The communication engine 1002 may be software or instructions stored on a computer-readable medium that allows the device 1000 to send and receive information over the network 710. The recommendation engine 1004 may be software or instructions stored on a computer-readable medium that is operable to store payment service data in the database, store customer offer data in the databases, receive identifying information about a merchant, retrieve subsets of customers using identifying information about a merchant, review customer offer data using subsets of customers to determine results of providing offers to that subset of customers, determine offers with the highest amount of participation results, provide offers to merchants, receive selections of offers by merchants, provide offers to customers, filters customer offer data, determine estimated benefits for merchants based on recommended offers, and provide any of the other functionality that is discussed above. While the databases 1006-1014 have been illustrated as separate from each other and located in the system provider device 1000, one of skill in the art will recognize that any or all of the databases 1006-1014 may be combined and/or may be connected to the recommendation engine 1004 through the network 710 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and customers; however, a customers or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person interacting with a customer. Having thus described embodiments of the present disclosure, persons of ordinary skill in the art will recognize that changes may be made in form and detail without departing from the scope of the present disclosure. Thus, the present disclosure is limited only by the claims.

1. A merchant offer recommendation system, comprising:
a non-transitory memory storing customer offer data for a plurality of customers and a plurality of offers, wherein the customer offer data details the results of providing one or more of the plurality of offers to each of the plurality of customers;
one or more hardware processors coupled to the memory and operable to read instructions from the memory to perform the steps of:
receiving identifying information about a first merchant;
retrieving a first subset of the plurality of customers that are associated with the first merchant from the non-transitory memory using the identifying information about the first merchant;
reviewing the customer offer data in the non-transitory memory using the first subset of the plurality of customers to determine the results of providing the one or more of the plurality of offers to each of the first subset of customers;
determining a first offer of the plurality of offers that is associated with a higher amount of participation results by the first subset of the plurality of customers relative to the others of the plurality of offers;
determining an estimated amount of additional revenue that providing the first offer to the first subset of the plurality of customers could generate for the first merchant; and
providing the first offer and the estimated amount of additional revenue over a network for display to the first merchant.

2. The system of claim 1, wherein the one or more hardware processors are operable to read instructions from the memory to perform the steps of:
receiving a selection of the first offer by the first merchant over the network; and
providing the first offer over the network to the first subset of customers.

3. The system of claim 1, wherein the customer offer data details the identity of the merchant that provided each offer to the each of the plurality of customers, and wherein the one or more processors are operable to read instructions from the memory to perform the steps of:
filtering the customer offer data using the first merchant to determine a first subset of the plurality of offers that were provided by merchants that are the same type of merchant as the first merchant, wherein the first offer is determined from the first subset of the plurality of offers.

4. The system of claim 1, wherein the retrieving the first subset of the plurality of customers that are associated with the first merchant includes:
determining that the first subset of the plurality of customers are ranked higher than a superset of the plurality of customers that are associated with the first merchant based on each of the first subset of the plurality of customers including at least one of a higher number of transactions, a higher frequency of transactions, and a higher transaction amount than the superset of the plurality of customers.

5. The system of claim 1, wherein the higher amount of participation results by the first subset of the plurality of customers includes a higher percentage of the first subset of the plurality of customers participating in the first offer relative to the other of the plurality of offers.

6. The system of claim 1, wherein the higher amount of participation results by the first subset of the plurality of customers includes a higher revenue resulting from the first subset of the plurality of customers participating in the first offer relative to the others of the plurality of offers.

7. A method for recommending offers to merchants, comprising:
receiving, by an system provider device, identifying information about a first merchant;
retrieving, by the system provider device from a database using the identifying information about the first merchant, a first subset of a plurality of customers that are associated with the first merchant in a database;
reviewing, by the system provider device, customer offer data in the database that details the results of providing one or more of a plurality of offers to each of the plurality of customers, wherein the reviewing includes using the first subset of the plurality of customers to determine the results of providing the one or more of the plurality of offers to each of the first subset of customers;
determining, by the system provider device, a first offer of the plurality of offers that is associated with a higher amount of participation results by the first subset of the plurality of customers relative to the other of the plurality of offers;
providing, by the system provider device over a network, the first offer and the estimated amount of additional revenue for display to the first merchant.

8. The method of claim 7, further comprising:
receiving, by the system provider device over the network, a selection of the first offer by the first merchant; and
providing, by the system provider device over the network, the first offer to the first subset of customers.

9. The method of claim 7, further comprising:
filtering, by the system provider device, the customer offer data using the first merchant to determine a first subset of the plurality of offers that were provided by merchants that are the same type of merchant as the first merchant, wherein the first offer is determined from the first subset of the plurality of offers.

10. The method of claim 7, the retrieving the first subset of the plurality of customers that are associated with the first merchant includes:
determining, by the system provider device, that the first subset of the plurality of customers are ranked higher than a superset of the plurality of customers that are associated with the first merchant based on each of the first subset of the plurality of customers including at least one of a higher number of transactions, a higher frequency of transactions, and a higher transaction amount than the superset of the plurality of customers.

11. The method of claim 7, wherein the higher amount of participation results by the first subset of the plurality of customers includes a higher percentage of the first subset of the plurality of customers participating in the first offer relative to the others of the plurality of offers.

12. The method of claim 7, wherein the higher amount of participation results by the first subset of the plurality of customers includes a higher revenue resulting from the first subset of the plurality of customers participating in the first offer relative to the others of the plurality of offers.

13. The method of claim 7, wherein the determining, by the system provider device, the first offer of the plurality of offers that is associated with a higher amount of participation results by the first subset of the plurality of customers relative to the others of the plurality of offers includes determining, by the system provider device, a first offer type associated with a first subset of the plurality of offers, and determining, by the system provider device, the first offer of the first subset of the plurality of offers that includes a first offer configuration that is associated with a higher amount of participation results by the first subset of the plurality of customers relative to the offer configurations of the others of the first subset of the plurality of offers.

14. A non-transitory machine-readable medium comprising a plurality of machine-readable instructions which, when executed by one or more processors, are adapted to cause the one or more processors to perform a method comprising:
receiving identifying information about a first merchant;
retrieving a first subset of a plurality of customers that are associated with the first merchant in a database using the identifying information about the first merchant;
reviewing customer offer data in the database that details the results of providing one or more of a plurality of offers to each of the plurality of customers, wherein the reviewing includes using the first subset of the plurality of customers to determine the results of providing the one or more of the plurality of offers to each of the first subset of customers;
determining a first offer of the plurality of offers that is associated with a higher amount of participation results by the first subset of the plurality of customers relative to the others of the plurality of offers;
determining an estimated amount of additional revenue that providing the first offer to the first subset of the plurality of customers could generated for the first merchant; and
providing the first offer and the amount of additional revenue over a network for display to the first merchant.

15. The non-transitory machine-readable medium of claim 14, wherein the method further comprises:
receiving a selection of the first offer by the first merchant over the network; and
providing the first offer over the network to the first subset of customers.

16. The non-transitory machine-readable medium of claim 14, wherein the method further comprises:
filtering the customer offer data using the first merchant to determine a first subset of the plurality of offers that were provided by merchants that are the same type of merchant as the first merchant, wherein the first offer is determined from the first subset of the plurality of offers.

17. The non-transitory machine-readable medium of claim 14, wherein the retrieving the first subset of the plurality of customers that are associated with the first merchant includes:
determining that the first subset of the plurality of customers are ranked higher than a superset of the plurality of customers that are associated with the First merchant based on each of the first subset of the plurality of customers including at Least one of a higher number of transactions, a higher frequency of transactions, and a Higher transaction amount than the superset of the plurality of customers.

18. The non-transitory machine-readable medium of claim 14, wherein the higher amount of participation results by the first subset of the plurality of customers includes a higher percentage of the first subset of the plurality of customers participating in the first offer relative to the others of the plurality of offers.

19. The non-transitory machine-readable medium of claim 14, wherein the higher amount of participation results by the first subset of the plurality of customers includes a higher revenue resulting from the first subset of the plurality of customers participating in the first offer relative to the others of the plurality of offers.

20. The non-transitory machine-readable medium of claim 14, wherein the determining the first offer of the plurality of offers that is associated with a higher amount of participation results by the first subset of the plurality of customers relative to the others of the plurality of offers includes determining a first offer type associated with a first subset of the plurality of offers, and determining the first offer of the first subset of the plurality of offers that includes a first offer configuration that is associated with a higher amount of participation results by the first subset of the plurality of customers relative to the offer configurations of the others of the first subset of the plurality of offers.
